(19) United States
(12) Patent Application Publication
(10) Pub. No.: US 2013/0006489 A1
(43) Pub. Date: Jan. 3, 2013

(54) METHOD AND SYSTEM OF CONTROLLING A POWERTRAIN FOR HYBRID VEHICLE

(75) Inventor: Sang Joon Kim, Seoul (KR)

(73) Assignee: HYUNDAI MOTOR COMPANY, Seoul (KR)

(21) Appl. No.: 13/312,412

(22) Filed: Dec. 6, 2011

(30) Foreign Application Priority Data
Jun. 29, 2011 (KR) 10-2011-0063836

(51) Int. Cl. B60W 10/02; B60W 20/00; F02N 11/08

(52) U.S. Cl. 701/68; 477/5; 903/930

(57) ABSTRACT

A method and a system of controlling a powertrain for a hybrid vehicle which is configured to start an engine and use power from the engine even though a starting motor has failed. More specifically, a controller is configured to determine whether the starting motor has failed or not and if the starting motor has failed, a first clutch is engaged to lock a first planetary gear set to start the engine with power from the drive motor. Furthermore, while operating the vehicle, power may be supplied from just the drive motor, just the engine or both even when the starting motor has failed.

### CROSS-REFERENCE TO RELATED APPLICATION

This application claims priority to and the benefit of Korean Patent Application No. 10-2011-0063836 filed in the Korean Intellectual Property Office on Jun. 29, 2011, the entire contents of which are incorporated herein by reference.

### BACKGROUND OF THE INVENTION

(a) Field of the Invention

The present invention relates to a method and a system of controlling a powertrain in a hybrid vehicle. More particularly, the present invention relates to a method and a system that controls the powertrain when a starting motor of the hybrid vehicle fails.

(b) Description of the Related Art

Generally, hybrid vehicles include both a motor and an engine. A powertrain of the hybrid vehicle may include a starting motor that is separate from the drive motor. In this instance, the starting motor, drive motor, and engine are connected with at least one planetary gear set and at least one friction member. In addition, a plurality of shift modes are implemented according to a connectional structure of each planetary gear set and friction member.

A starting motor is typically defined as a motor that is configured to rotate a crankshaft which in turn starts the engine. A drive motor, however, is typically defined as a motor which powers the vehicle's drivetrain directly. The starting motor and the drive motor are each operated by electricity supplied from a battery. To propel the vehicle in a desired direction, a drive shaft is rotated by selective operation of the drive motor and the engine.

However, if the starting motor fails, the engine cannot be started in if a vehicle is utilizing the conventional powertrain described above. In addition, since power supplied from the engine cannot be used and regenerative braking cannot be carried out. Therefore, in this situation, the hybrid vehicle can only be powered/driven by power supplied by the drive motor. Even worse, however, if SOC (State Of Charging) of the battery is depleted, the vehicle cannot be driven at all.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and a system of controlling a powertrain for a hybrid vehicle which is able to start an engine and use the power from the engine even when a starting motor has failed. Additionally, the present invention improves marketability and reliability of hybrid vehicles by enabling regenerative braking even though a starting motor has failed.

A method of controlling a powertrain for a hybrid vehicle according to an exemplary embodiment of the present invention controls the powertrain of the hybrid vehicle once a starting motor, which is configured start an engine, has failed. The hybrid vehicle also includes a drive motor that is configured to supply power for driving the vehicle, and at least one of planetary gear set and at least one friction member.

The method may include: determining, by a controller, whether a starting motor has failed or not and in response to determining that the starting motor has failed, starting the engine with power from the drive motor. In this case, the vehicle is driven only with power provided from the drive motor until it is determined that engine power should be used in addition or in place of the drive motor. Accordingly, the controller then determines whether power from the engine should be used; and in response to determining that power from the engine should be used, applying power from engine and the drive motor.

Additionally, the controller may also be configured to control the vehicle is to be stopped while the vehicle is operating. More specifically, the drive motor is stopped. Additionally, the engine may be controlled to be an idle state once the engine is started.

A system of controlling a powertrain for a hybrid vehicle according to another exemplary embodiment of the present invention may include: an engine configured to be a first power source; a starting motor configured to start the engine; and a drive motor configured to be a second power source. The system also includes a first planetary gear set having a first sun gear, a first planet carrier, and a first ring gear as operating members thereof. The first planet carrier is directly connected to the engine and the first ring gear is directly connected to the starting motor. A second planetary gear set includes a second sun gear, a second planet carrier, and a second ring gear as operating members thereof. The second sun gear is directly connected to the first sun gear and the drive motor, and the second planet carrier is directly connected to an output shaft. A first clutch is configured to engage the first planetary gear set with a second clutch which is configured to selectively connect the first planet carrier with the second ring gear.

Furthermore, a first brake selectively connects the first ring gear with a transmission case and a second brake selectively connects the second ring gear with the transmission case. A control portion is configured to control operations of the engine, the starting motor, the drive motor, the first and second clutches, and the first and second brakes accordingly. In particular, the control portion is configured to operate the first clutch and release the second brake to transfer power from the drive motor to the engine, and thereby start the engine upon the control portion detecting that the starting motor has failed.

The control portion may release the first clutch so as to control the engine to be an idle state once the starting of the engine is completed. Additionally, the control portion may be configured to operate the second brake when the vehicle should be driven only by the power from the drive motor once the engine is started, and to engage the first clutch when the vehicle should be driven at least partially by power from the engine once the engine is started. Furthermore, the control portion may be configured to release the first clutch and stop the drive motor when the vehicle is to be stopped.

The control portion may include: an engine control unit configured to control the engine; a transmission control unit configured to control the first and second clutches and the first and second brakes; and a motor control unit configured to control the starting motor and the drive motor.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a schematic diagram of a powertrain for a hybrid vehicle according to an exemplary embodiment of the present invention.

FIGS. 2A-F is speed diagram at each step included in a method of controlling a powertrain for a hybrid vehicle according to an exemplary embodiment of the present invention.

FIG. 3 is a flowchart of a method of controlling a powertrain for a hybrid vehicle according to an exemplary embodiment of the present invention.

FIG. 4 is a block diagram of a system of controlling a powertrain for a hybrid vehicle according to an exemplary embodiment of the present invention.

### DESCRIPTION OF SYMBOLS

10: engine

20: starting motor

30: drive motor

40: battery

50: transmission case

55: transmission

60: central control unit

70: engine control unit

80: motor control unit

90: transmission control unit

100: control portion

OS: output shaft

PG1: first planetary gear set

S1: first sun gear

PC1: first planet carrier

R1: first ring gear

PG2: second planetary gear set

S2: second sun gear

PC2: second planet carrier

R2: second ring gear

CL1: first clutch

CL2: second clutch

BK1: first brake

BK2: second brake

IS1: first input shaft

IS2: second input shaft

### DETAILED DESCRIPTION OF THE EMBODIMENTS

An exemplary embodiment of the present invention will hereinafter be described in detail with reference to the accompanying drawings.

It is understood that the term hybrid “vehicle” or “vehicular” or other similar term as used herein is inclusive of all types of hybrid motor vehicles in general such as passenger automobiles including sports utility vehicles (SUV), buses, trucks, various commercial vehicles, watercraft including a variety of boats and ships, aircraft, and the like, and includes electric hybrid vehicles, plug-in hybrid electric vehicles, hydrogen-powered hybrid vehicles and other alternative fuel hybrid vehicles (e.g. fuels derived from resources other than petroleum). As referred to herein, a hybrid vehicle is a vehicle that has two or more sources of power, for example both gasoline-powered and electric-powered vehicles.

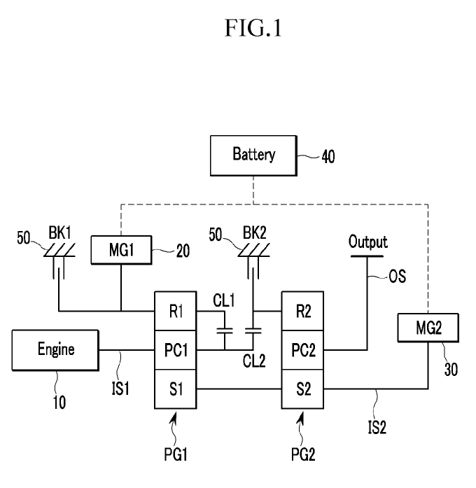

FIG. 1 is a schematic diagram of a powertrain for a hybrid vehicle according to an exemplary embodiment of the present invention. As shown in FIG. 1, a powertrain for a hybrid vehicle according to an exemplary embodiment of the present invention includes an engine 10, a starting motor 20, a drive motor 30, first and second input shafts IS1 and IS2, an output shaft OS, and first and second planetary gear sets PG1 and PG2.

The engine 10 delivers power to the first input shaft IS1. The starting motor 20 delivers power to the engine 10 so as to start the engine 10 by applying power to and through the first planetary gear set to the engine 10. The drive motor 30 delivers power to the second input shaft IS2. The starting motor 20 and the drive motor 30 receive electricity from a battery 40 and are operated so as to generate power therefrom.

The first input shaft IS1 delivers the power received by selective operation of the engine 10 to the first planetary gear set PG1. The second input shaft IS2 delivers the power received by selective operation of the drive motor 30 to the second planetary gear set PG2. The output shaft OS outputs power generated by the powertrain from the second planetary gear set PG2.

The first planetary gear set PG1 may be a single pinion planetary gear set having a first sun gear 51, a first planet carrier PC1, and a first ring gear R1 as operating members thereof. The first planet carrier PC1 rotatably supports a first pinion gear (not shown) engaged with the first sun gear 51 and the first ring gear R1, respectively.

The second planetary gear set PG2 is a single pinion planetary gear set having a second sun gear S2, a second planet carrier PC2, and a second ring gear R2 as operating members thereof. The second planet carrier PC2 rotatably supports a second pinion gear (not shown) engaged with the second sun gear S2 and the second ring gear R2, respectively.

In the illustrative embodiment of the present invention, the first planetary gear set PG1 and the second planetary gear set PG2 are disposed on the same axis. The first sun gear S1 and the second sun gear S2 may be fixedly connected to the drive motor 30, and the first planet carrier PC1 may be fixedly connected to the engine 10. Additionally, the first planet carrier PC1 is selectively connected to the first ring gear R1, and is selectively connected to the second ring gear R2. A connection between the first planet carrier PC1 and the first ring gear R1 is different from the connection therebetween through the first pinion gear, in that it locks up the first planetary gear set PG1. The first ring gear R1 is fixedly/directly connected to the starting motor 20 and is selectively connected to a transmission case 50. The second ring gear R2 is selectively connected to the transmission case 50. The second planet carrier PC2 is fixedly/directly connected to the output shaft OS.

In addition, the powertrain for a hybrid vehicle according to an exemplary embodiment of the present invention also includes a plurality of friction members CL1, CL2, BK1, and BK2 which connect operating members of the first and second planetary gear sets PG1 and PG2 with each other or with the transmission case 50. The first clutch CL1 selectively connects the first planet carrier PC1 with the first ring gear R1, and the second clutch CL2 selectively connects the first planet carrier PC1 with the second ring gear R2. The first brake BK1 selectively connects the first ring gear R1 with the transmission case 50, and the second brake BK2 selectively connects the second ring gear R2 with the transmission case 50.

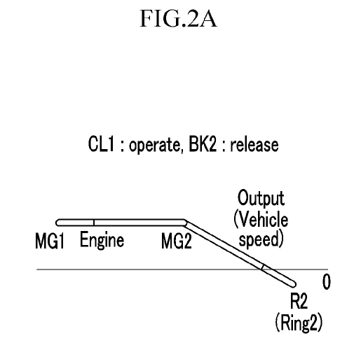

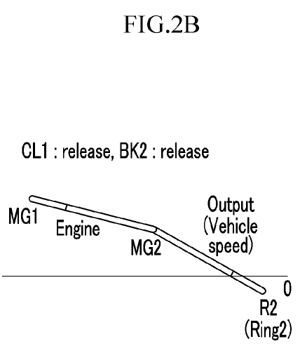

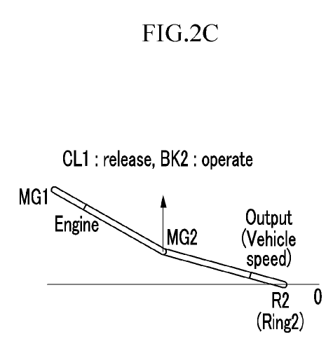

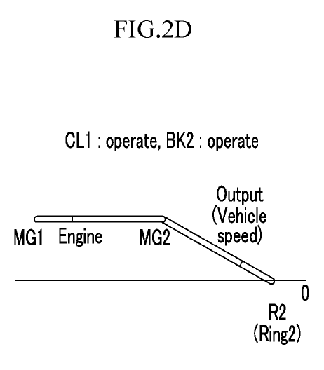

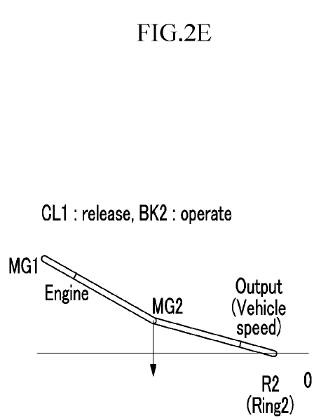

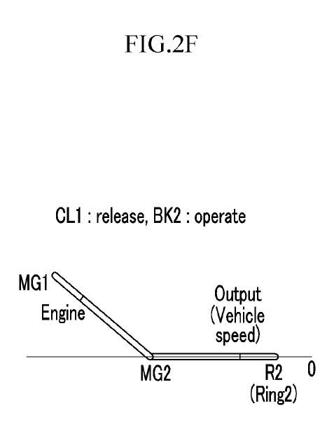

FIG. 2 is speed diagram at each step included in a method of controlling a powertrain for a hybrid vehicle according to an exemplary embodiment of the present invention.

As shown in FIG. 2, the method of controlling the powertrain for a hybrid vehicle according to an exemplary embodiment of the present invention is configured to accelerate and decelerate the vehicle by selectively using power from either the engine 10, the drive motor 30, or both even if the starting motor fails. Such operation is performed by controlling the first clutch CL1 and the second brake BK2.

Referring to FIG. 1 and FIG. 2, each step of the method of controlling the powertrain for a hybrid vehicle according to an exemplary embodiment of the present invention will be described. Prior to explaining each step of the method, it is assumed that the second clutch CL2 and the first brake BK2 necessary for achieving a plurality of shift modes are released in the exemplary embodiment of the present invention.

FIG. 2A shows a step where the engine 10 is started by using the power of the drive motor 30. Once the drive motor 30 begins operating by electricity from the battery 40, the second sun gear S2 fixedly connected to the drive motor 30 through the second input shaft IS2 and the first sun gear S1 fixedly connected to the second sun gear S2 are rotated at the same speed. When the first clutch CL1 is operated and the second brake BK2 is released at this time, the first planet carrier PC1 and the first ring gear R1 are connected to each other by operation of the first clutch CL1 and three operating members S1, PC1, and R1 included in the first planetary gear set PG1 are “locked together” and rotated at the same speed. Therefore, the power from the drive motor 30 is delivered to the engine 10 fixedly connected to the first planet carrier PC1 through the first input shaft IS1 and the engine 10 is thereby started. At this time, the second planet carrier PC2 does not rotate and is maintained in a stopped state. Accordingly, it is assumed that the vehicle is started at the stopped state. However, the vehicle can be started at a running state as well. At this time, since the second brake BK2 is not operated, the second ring gear R2 rotates according to speeds of the second sun gear S2 and the second planet carrier PC2.

FIG. 2B shows a step where the engine 10 is controlled to be an idle state after being started. When the first clutch CL1 is released from the step shown in FIG. 2A, the engine 10 is controlled to be the idle state and is accelerated to a predetermined speed. In addition, since the engine 10 and the drive motor 30 are not bound with each other, the drive motor 30 rotates with an original speed and the vehicle is maintained in the stopped state.

FIG. 2C shows a step where the vehicle is driven only by the drive motor 30. When the second brake BK2 is operated from the step shown in FIG. 2B, the second ring gear R2 is stopped/disengaged and the second planet carrier PC2 rotates with a constant speed. That is, the vehicle runs at a constant speed by power from just the drive motor 30. Furthermore, release of the first clutch CL1 and operation of the second brake BK2 can be performed simultaneously at the steps shown in FIG. 2B and 2C.

FIG. 2D shows a step where the vehicle is accelerated by using the power of the engine 10. If the first clutch CL1 is engaged from the step shown in FIG. 2C, the first planet carrier PC1 and the first ring gear R1 are connected and three operating members S1, PC1, and R1 of the first planetary gear set PG1 rotate at the same speed. Therefore, the speed of the engine 10 is input into the second planetary gear set PG2 through the first and second sun gears S1 and S2, the power of the engine 10 and the power of the drive motor 30 are combined, and the vehicle is accelerated.

FIG. 2E, the same as FIG. 2C, shows a step where the vehicle is driven only by the drive motor 30. However, FIG. 2C shows the step where the vehicle begins to drive in the stopped state, and FIG. 2E shows the step where the vehicle is decelerated from the accelerated state by the power of the engine 10. When the first clutch CL1 is released from the step shown in FIG. 2D, the engine 10 is controlled again to be the idle state and the drive motor 30 rotates at it's the original speed. That is, the vehicle is decelerated to a speed with which the vehicle is rotated only by the power of the drive motor 30.

FIG. 2F shows a step where the vehicle is stopped. When the drive motor 30 is stopped from the steps shown in FIG. 2C and FIG. 2E, three operating members S2, PC2, and R2 of the second planetary gear set PG2 are also stopped. Therefore, the vehicle is stopped. In addition, the vehicle can be stopped by releasing the first clutch and stopping the drive motor 30 from the step shown in FIG. 2D.

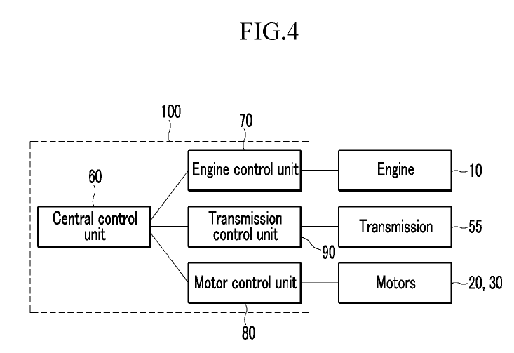

Above mentioned operations explained by referring to FIGS. 1 and 2 can be performed by a control portion 60 shown in FIG. 4. The control portion 100 includes a central control unit 60, an engine control unit 70, a transmission control unit 90, and a motor control unit 80. The central control unit 60 receives from or delivers to the engine control unit 70, the transmission control unit 90, and the motor control unit 80 signals according to a driving condition of the vehicle and controls each constituent element. The engine control unit 70 and the motor control unit 80 control the engine 10 and the motors 20 and 30, respectively. In addition, the transmission control unit 90 converts the powers of the engine 10 and/or the motors 20 and 30 by a predetermined gear ratio by operating or releasing the friction members CL1, CL2, BK1, and BK2. That is, the transmission control unit 90 controls the transmission 55.

Such control units are well known to a person of an ordinary skill in the art, and thus detailed description thereof will be omitted. A plurality of control units is described in this specification, but they are not limited thereto. In one or more embodiments, one control unit can control the constituent elements. However, more than one control unit may be applied.

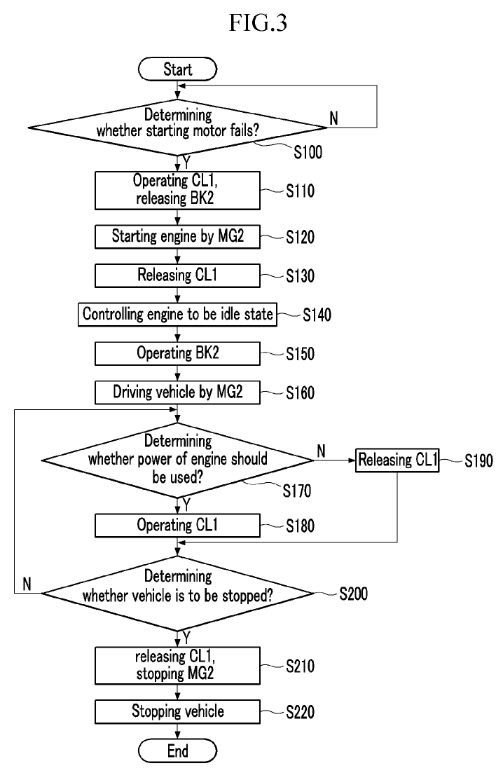

FIG. 3 is a flowchart of a method of controlling a powertrain for a hybrid vehicle according to an exemplary embodiment of the present invention. As shown in FIG. 3, when the engine 10 should be started, it is determined whether the starting motor 20 for starting the engine 10 has failed or not by the above described control portion at step S100. Such a failure determination step performed at the step S100 can be performed in advance just in case the power of the engine 10 is necessary immediately. If the starting motor 20 does not fail, the engine 10 can be started normally by using the power from the starting motor 20 and the control portion 100 returns to the step S100.

When the starting motor 20 does fail, the control portion 100 is configured to operate the first clutch CL1 and release the second brake BK2 at step S110. Therefore, the engine 10 can be started by using the power from the drive motor 30 at step S120, as shown in FIG. 2A. Since three operating members S1, PC1, and R1 of the first planetary gear set PG1 are rotated integrally by operation of the first clutch CL1, the engine 10 receives the power from the drive motor 30 and is started therefrom.

When the drive motor 30 is not currently running, the control portion 100 starts the drive motor 30 before performing the step S110. once the engine 10 is started, the control portion 100 releases the first clutch CL1 at step S130. Therefore, the engine 10 is then controlled to be the idle state at step S140 as shown in FIG. 2B. In addition, when the engine 10 is controlled to be the idle state, the speed of the engine 10 increases to the predetermined speed.

When the engine 10 is controlled to be the idle state, the control portion 100 operates the second brake BK2 at step S150. Therefore, the vehicle runs at the predetermined/desired speed by via only the power from the drive motor 30 at a step S160 as shown in FIG. 2C. That is, since the second ring gear R2 is stopped by operation of the second brake BK2, only the second planet carrier PC2 and the second sun gear 2 rotate at the predetermined speed. Therefore, the vehicle runs at that predetermined/desired speed. Alternatively, the steps S130 to S160 can be simultaneously performed for efficiently purposes.

While the vehicle is being driven, the control portion 100 determines whether the power from the engine 10 should be used at a step S170. When the power from the engine 10 should be used at the step S170, the control portion 100 is configured to operate and engage the first clutch CL1 at a step S180. Once the first clutch CL1 is operated, the power from the engine 10 is delivered to the second planetary gear set PG2 through the first and second sun gears S1 and S2 as shown in FIG. 2D.

When the power from the engine 10 should not be used, the first clutch CL1 is left disengaged by the control portion 100 at a step S190. In this case, the engine 10 is controlled to be in an idle state and the drive motor 30 rotates at it's the original speed. That is, since the engine 10 and the drive motor 30 are not mechanically engaged, the vehicle is driven via only power from the drive motor 30.

After that, the control portion 100 determines whether the vehicle is to be stopped at a step S200. If the vehicle is not to be stopped, the control portion 100 returns to the step S170. If the vehicle is to be stopped, the control portion 100 releases the first clutch CL1 and stops the drive motor 30 at a step S210. Since the drive motor 30 is stopped while the second ring gear R2 is also fixed, three operating members S2, PC2, and R2 of the second planetary gear set PG2 are also stopped as shown in FIG. 2F. In addition, since the first clutch CL1 is released, the power from the engine 10 is not delivered to the second planetary gear set PG2. Therefore, the vehicle is completely stopped at a step S220.

Furthermore, the control logic of the present invention may be embodied as computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion.

Advantageously, according to the illustrative exemplary embodiment of the present invention, an engine can be started and power from the engine can be applied to the drive train in a hybrid vehicle even though a starting motor has failed. Therefore, the hybrid vehicle can run normally even though a starting motor fails. In addition, regenerative braking can be carried out even though the starting motor fails. Therefore, marketability and reliability of the hybrid vehicle can be improved.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of controlling a powertrain for a hybrid vehicle, the powertrain having a starting motor configured start an engine, a drive motor configured to supply power for driving the vehicle, and at least one planetary gear set and at least one friction member, the method comprising:
determining, by a controller, whether the starting motor has failed;
in response to determining that the starting motor has failed, controlling, by the controller, a first clutch to enable the drive motor to start the engine with power from the drive motor;
powering the vehicle only with the power from the drive motor when power from the engine is not required;
determining, by the controller, whether power from the engine is required while the vehicle is being operated only with power from the drive motor; and
in response to determining that power from the engine is required, powering the vehicle using power from the engine and the drive motor by engaging the first clutch.

2. The method of claim 1, further comprising:
determining whether the vehicle is to be stopped while the vehicle is being operated; and
in response to determining that the vehicle should be stopped, stopping the drive motor.

3. The method of claim 1, wherein the engine is controlled to be an idle state upon starting the engine.

4. A system for controlling a powertrain for a hybrid vehicle, comprising:
an engine configured to be a first power source;
a starting motor configured to start the engine;
a drive motor configured to be a second power source;
a first planetary gear set having a first sun gear, a first planet carrier, and a first ring gear as operating members thereof, wherein the first planet carrier is directly connected to the engine and the first ring gear is directly connected to the starting motor;
a second planetary gear set having a second sun gear, a second planet carrier, and a second ring gear as operating members thereof, wherein the second sun gear is directly connected to the first sun gear and the drive motor, and the second planet carrier is directly connected to an output shaft;
a first clutch configured to lock up the first planetary gear set a second clutch configured to selectively connect the first planet carrier with the second ring gear;
a first brake configured to selectively connect the first ring gear with a transmission case;
a second brake configured to selectively connect the second ring gear with the transmission case; and
a control portion configured to control the operation of the engine, the starting motor, the drive motor, the first and second clutches, and the first and second brakes,
wherein the control portion engages the first clutch and releases the second brake to transfer power from the drive motor to the engine to start the engine when a starting motor fails.

5. The system of claim 4, wherein the control portion releases the first clutch to control the engine to be an idle state once starting of the engine is completed.

6. The system of claim 5, wherein the control portion operates the second brake when the vehicle is to be driven only by the power from the drive motor after the engine has been started.

7. The system of claim 5, wherein the control portion engages the first clutch when the vehicle is to be driven by power from the engine once the engine is started.

8. The system of claim 4, wherein the control portion releases the first clutch and stops the drive motor when the vehicle is to be stopped.

9. The system of claim 4, wherein the control portion comprises:
an engine control unit configured to control the engine;
a transmission control unit configured to control the first and second clutches and the first and second brakes; and
a motor control unit configured to control the starting motor and the drive motor.

10. A computer readable medium containing executable program instructions executed by a controller, for controlling a powertrain for a hybrid vehicle, the computer readable medium comprising:
program instructions that determine whether a starting motor has failed in the hybrid vehicle;
program instructions that control a first clutch to enable a drive motor to start an engine with power from the drive motor in response to determining that the starting motor has failed;
program instructions that power the vehicle only with the power from the drive motor when power from the engine is not required;
program instructions that determine whether power from the engine is required while the vehicle is being operated only with power from the drive motor; and
program instructions that power the vehicle using power from the engine and the drive motor by engaging the first clutch in response to determining that power from the engine is required.

11. The computer readable medium of claim 10, further comprising:
program instructions that determine whether the vehicle is to be stopped while the vehicle is being operated; and
program instructions that stop the drive motor in response to determining that the vehicle should be stopped in response to determining that the vehicle should be stopped.

12. The computer readable medium of claim 10, wherein the program instructions control the engine to be in an idle state upon starting the engine.

13. The computer readable medium of claim 12, further comprising program instructions that release the first clutch to control the engine to be an idle state once starting of the engine is completed.

14. The system of claim 11, further comprising program instructions operate a second brake when the vehicle is to be driven only by the power from the drive motor after the engine has been started.

15. The system of claim 11, further comprising program instructions that engage the first clutch when the vehicle is to be driven by power from the engine once the engine is started.

16. The system of claim 11, further comprising program instructions that release the first clutch and stop the drive motor when the vehicle is to be stopped.
